(19) United States
(12) Patent Application Publication
(10) Pub. No.: US 2014/0246547 A1
(43) Pub. Date: Sep. 4, 2014

(54) INTEGRATED PORTABLE STAND, POWER SUPPLY, AND CONTROL PANEL

(71) Applicant: AIR SYSTEMS, INC. dba AIR SYSTEMS INTERNATIONAL, INC., Chesapeake, VA (US)

(72) Inventor: Lawrence Shane Intravatola, Virginia Beach, VA (US)

(73) Assignee: AIR SYSTEMS, INC. dba AIR SYSTEMS INTERNATIONAL, INC., Chesapeake, VA (US)

(21) Appl. No.: 14/276,667

(22) Filed: May 13, 2014

Related U.S. Application Data
(63) Continuation-in-part of application No. 29/469,816, filed on Oct. 15, 2013.
Application No. 29/469,816 is a continuation-in-part of application No. 13/376,156, filed on Mar. 23, 2012.
(60) Provisional application No. 61/183,950, filed on Jun. 3, 2009.

(51) Int. Cl. F16M 11/04

(52) U.S. Cl. CPC F16M 11/04; F16M 2200/08
USPC 248/125.8

(57) ABSTRACT

A stand includes a main housing having a power supply cavity and a control cavity in which a power supply and controller are respectively housed. The main housing also includes access ports for external connection with the power supply. The stand also includes a leg assembly attached to a first side wall of the main housing, the leg assembly allowing for outward extension of a first leg and a second leg to increase the stability of the stand. The stand further includes a telescoping mast attached to the main housing. The telescoping mast includes a mount for the selective attachment of a functional device thereto. A power and control conduit connects the power supply and mount for the transmission of electric power and control signals to the functional device.

### CROSS REFERENCE TO RELATED APPLICATIONS

This application is a continuation-in-part of U.S. Design patent application Ser. No. 29/469,816, entitled “HOUSING FOR A POWER SUPPLY AND CONTROLLER,” filed Oct. 15, 2013, and this application is continuation-in-part of 13/376,156, entitled “INTEGRATED PORTABLE STAND, POWER SUPPLY, AND CONTROL PANEL,” filed Mar. 23, 2012, which is currently pending, which is a national phase filing under 35 USC 371 of PCT/US10/37342, entitled “INTEGRATED PORTABLE STAND, POWER SUPPLY, AND CONTROL PANEL,” filed Jun. 3, 2010, which claims the benefit of U.S. Provisional Patent Application Ser. No. 61/183,950, entitled “INTEGRATED PORTABLE STAND, POWER SUPPLY, AND CONTROL PANEL,” filed Jun. 3, 2009.

### BACKGROUND OF THE INVENTION

1. Field of the Invention

The present invention relates to stands for supporting items in an elevated position with respect to the surroundings. More specifically, the invention relates to stands that are portable, easy to set up for use at site, easy to collapse for storage and transport, and that do not require connection of parts at a site of use to function nor disconnection of any parts after use in order to collapse the stand for storage and transport.

2. Description of the Related Art

While prior stands offer a variety of benefits, there remains a need for a stand that comprises an integrated power supply and controls. In addition, there remains a need for a stand that is robust, easy to set up and collapse, is self-contained, and yet can be made economically and with a minimal number of complex parts.

The need for temporary stands to support items at an elevated position with respect to their surroundings is ubiquitous. For example, temporary lighting is a common functional device that is required for dark and remote job sites. However, if there are multiple parts that need to be connected in the dark in order to set up a platform, work is delayed, injuries may occur and parts may be lost and/or not available at all. Even if there is light, a stand that is not self-contained and that requires connections of parts to erect for use may cause delays in the start of work at the job site while workers attempt to locate the various parts and piece the parts together.

It is further appreciated, stands are often used “on site” and dirt, mud, rocks and other materials may become lodged in the supporting structure of a stand. As such, any stand which is intended for outdoor use at remote job sites must be constructed in a manner ensuring the support structure will not be rendered nonfunctional or clogged by various environmental factors which may be encountered. Therefore, legs which may be mounted at the bottom of a housing would not be desirable because after the first time the housing is used on mud, etc., the mud can interfere with operation of the legs of the supporting structure.

It is appreciated that microphones, podium platforms, loudspeakers, cameras, sensors, and surveying equipment are some of only a wide variety of functional devices that require support by a stand and that would benefit from a stand that may be quickly collapsed for storage and transport. Further, a portable stand for different functional devices may be required for use at various locations over time. For example, a road crew that works at night may need to use a light stand and many other pieces of equipment.

As a result, a stand of small size, low weight and convenient set up and collapse is desired. The stand must also be robust for repetitive use, rough handling and corrosive environments. For use in dangerous environments, the stand and its components should be intrinsically safe. When deployed, the stand should be stable under expected conditions of use. For example, a stand for holding a work light should not tip over when set up in a location where there are strong winds and/or where it may be jostled by surrounding people and equipment. Job sites that have explosives, fire, or other safety hazards also require equipment to be intrinsically safe.

### SUMMARY OF THE INVENTION

It is, therefore, an object of the present invention to provide a stand including a main housing having a power supply cavity and a control cavity in which a power supply and controller are respectively housed. The main housing also includes access ports for external connection with the power supply. The stand also includes a leg assembly attached to a first side wall of the main housing, the leg assembly allowing for outward extension of a first leg and a second leg to increase the stability of the stand. The stand further includes a telescoping mast attached to the main housing. The telescoping mast includes a mount for the selective attachment of a functional device thereto. A power and control conduit connects the power supply and mount for the transmission of electric power and control signals to the functional device. The first side wall of the main housing is constructed such that it creates a V-shape and includes a first wall member extending from a center of the first side wall and a second wall member extending from a center of the first side wall, such the first wall member and the second wall member create a concave cavity in which the telescoping mast is mounted.

It is also an object of the present invention to provide a stand wherein the concave cavity, in conjunction with an arcuate wall member extending between the first wall member and the second wall member, define a protective containment structure through which the power and control conduit extends.

It is another object of the present invention to provide a stand wherein the leg assembly includes adjacent first and second panels respectively secured to the first wall member and the second wall member, the first panel having the first leg pivotally and slidably connected thereto and the second panel having the second leg pivotally and slidably connected thereto.

It is a further object of the present invention to provide a stand wherein each of the first and second panels includes an elongated vertical channel used in control of the retraction and extension of the first and second legs.

It is also an object of the present invention to provide a stand wherein the first leg includes a first end having a mount hole and a second end. A bolt passes through the channel of the first panel and the mount hole at the first end of the first leg to pivotally and slidably connect the first end of the first leg to the first panel. The second leg includes a first end having a mount hole and a second end. A bolt passes through the channel of the second panel and the mount hole at the first end of the second leg to pivotally and slidably connect the first end of the second leg to the first panel.

It is another object of the present invention to provide a stand including a first strut pivotally connected between the first panel and the first leg and a second strut pivotally connected between the second panel and the second leg.

It is a further object of the present invention to provide a stand wherein the first and second legs are pivotally coupled to the first side wall.

It is also an object of the present invention to provide a stand wherein the leg assembly includes a first base leg assembly to which the first leg is pivotally secured and a second base leg assembly to which the second leg is pivotally secured.

It is a further object of the present invention to provide a stand wherein the telescoping mast is secured within a recess formed at a meeting point of first wall member and the second wall member.

It is also an object of the present invention to provide a stand including a main housing having a power supply cavity and a control cavity in which a power supply and controller are respectively housed. The main housing also includes access ports for external connection with the power supply. A leg assembly is attached to a first side wall of the main housing, the leg assembly selectively moving between a retracted formation and an extended formation, and allowing for outward extension of a first leg and a second leg to increase the stability of the stand. A telescoping mast is attached to the main housing. The telescoping mast includes a mount for the selective attachment of a functional device thereto. A power and control conduit connects the power supply and mount for the transmission of electric power and control signals to the functional device. The first side wall of the main housing includes a first wall member extending from a center of the first side wall and a second wall member extending from a center of the first side wall, and the leg assembly includes adjacent first and second panels respectively secured to the first wall member and the second wall member. The first panel has the first leg pivotally and slidably connected thereto and the second panel has the second leg pivotally and slidably connected thereto.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a perspective view along the rear long side wall of the present stand with the legs retracted.

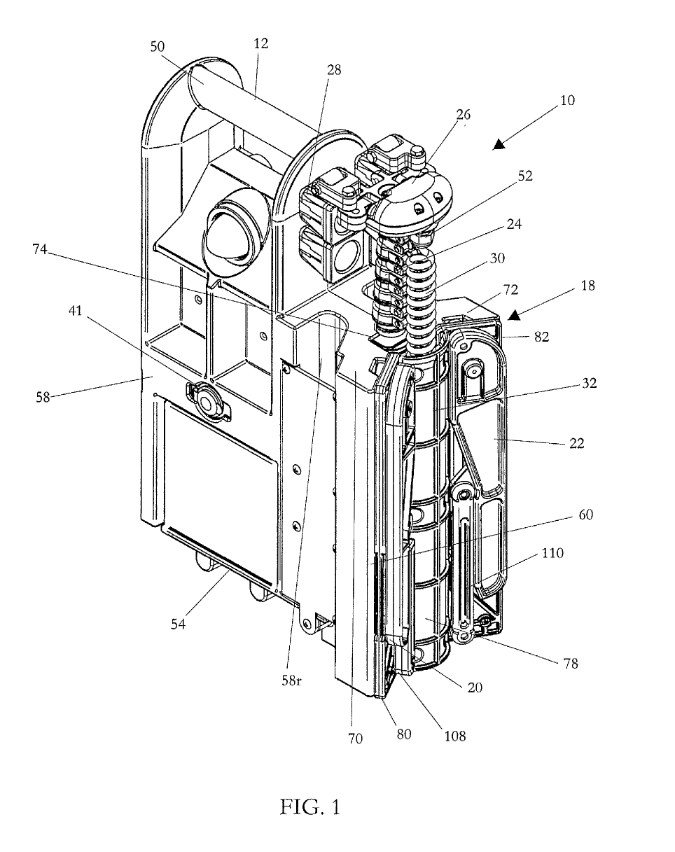

FIG. 2 is a perspective view along the rear long side wall of the present stand with the legs extended.

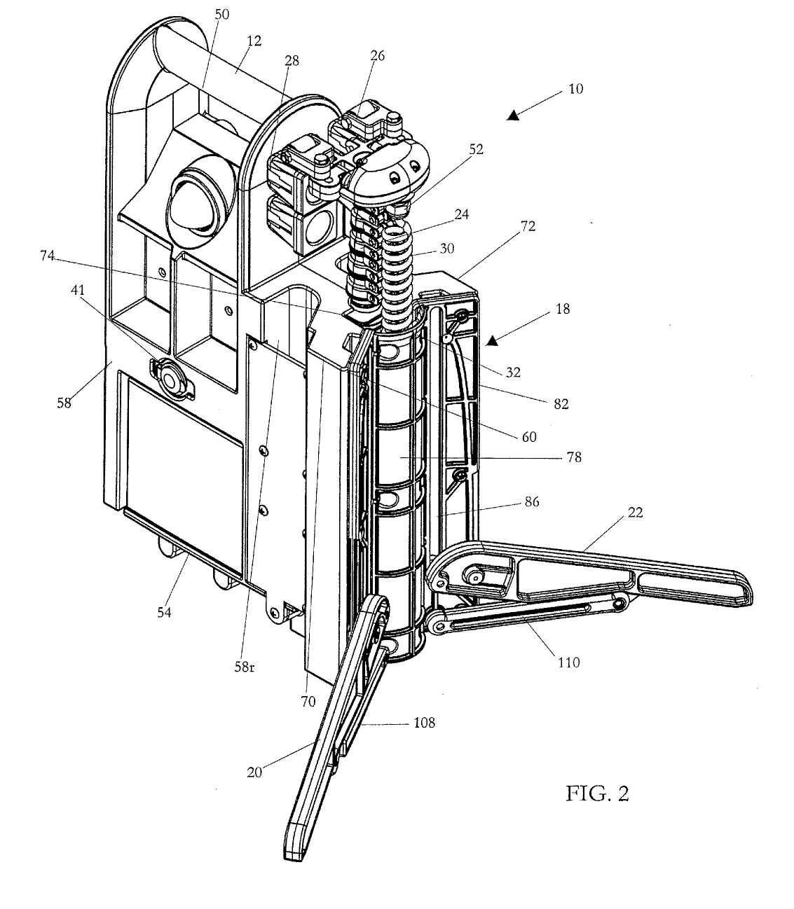

FIG. 3 is a side plan view of the front long side wall of the present stand with the legs retracted.

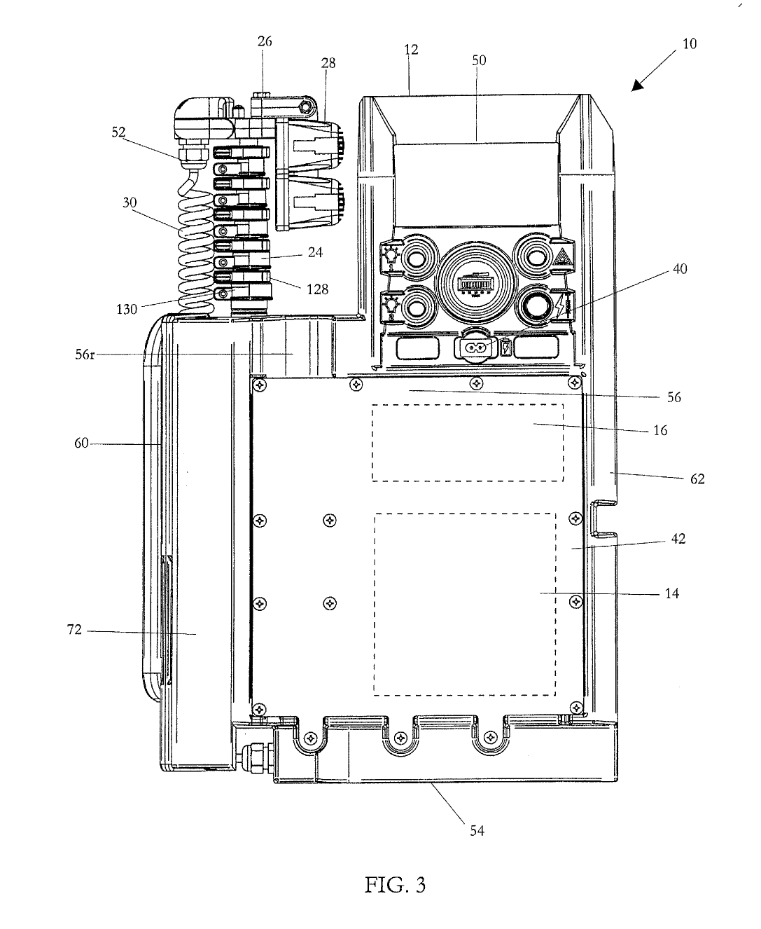

FIG. 4 is a side plan view of the front long side wall of the present stand with the legs extended.

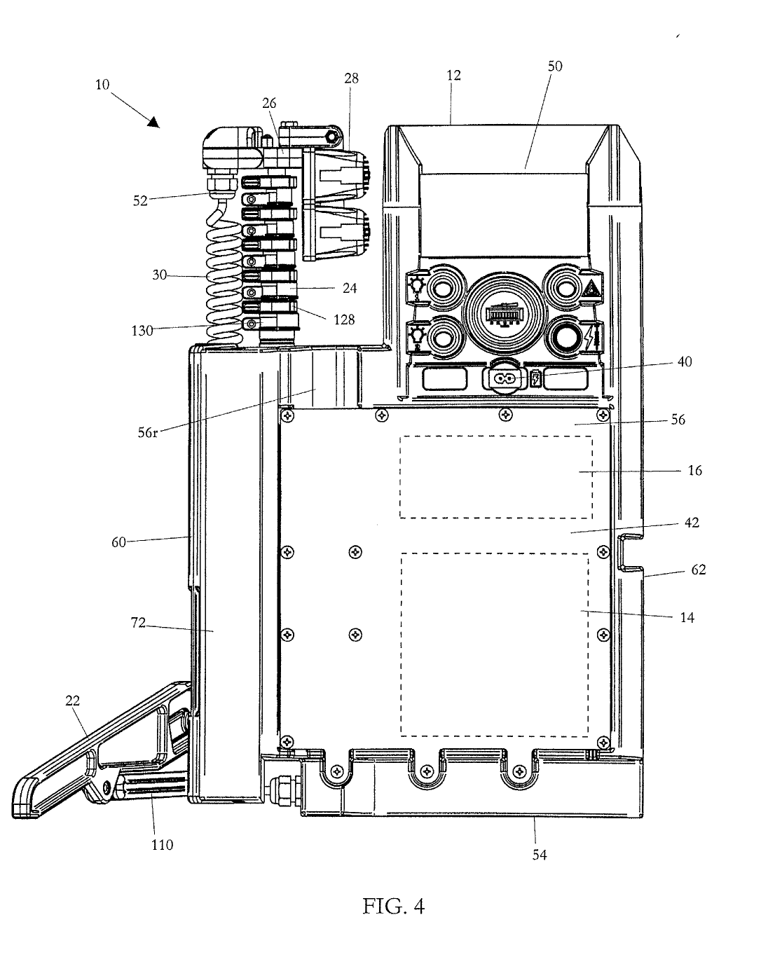

FIG. 5 is a side plan view of the first short side wall of the present stand with the legs retracted.

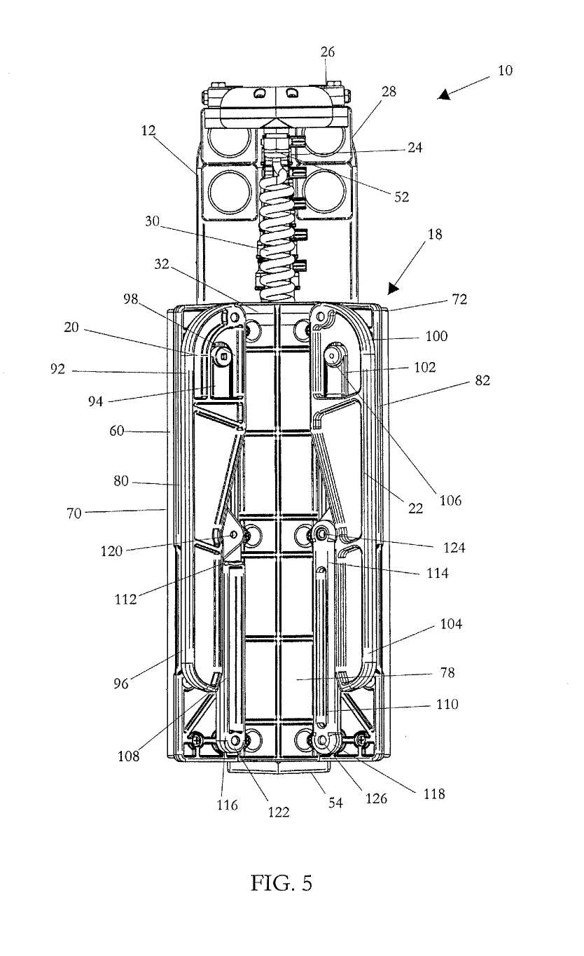

FIG. 6 is a side plan view of the first short side wall of the present stand with the legs extended.

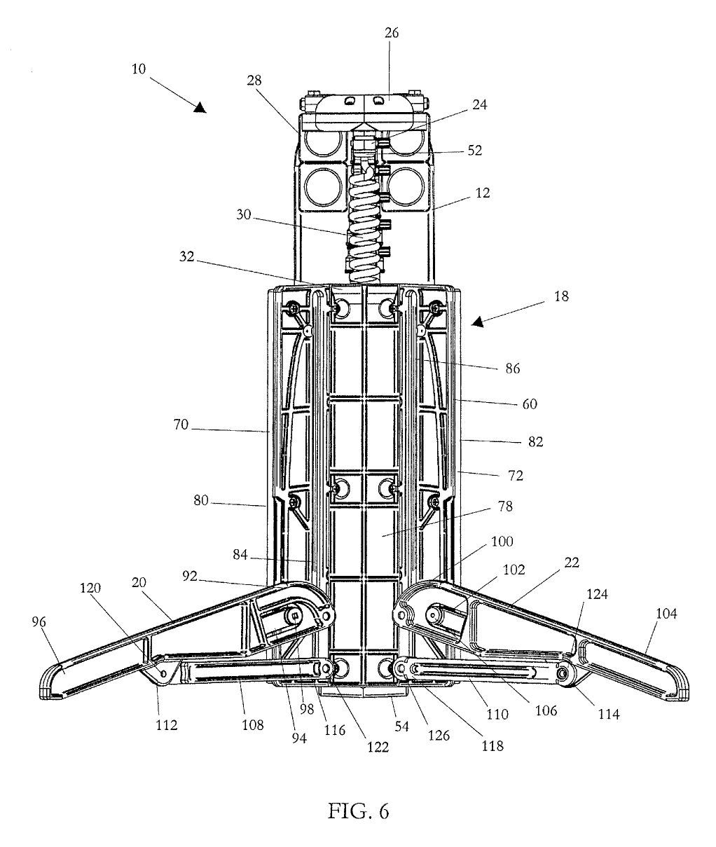

FIG. 7 is a side plan view of the rear long side wall of the present stand with the legs retracted.

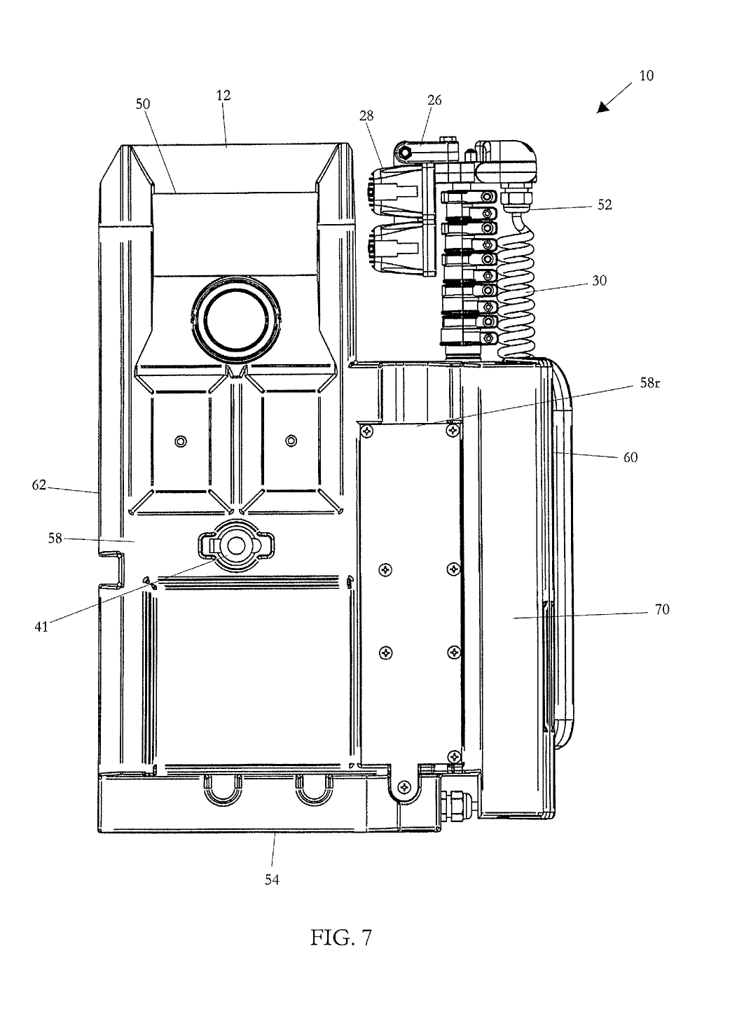

FIG. 8 is a side plan view of the rear long side wall of the present stand with the legs extended.

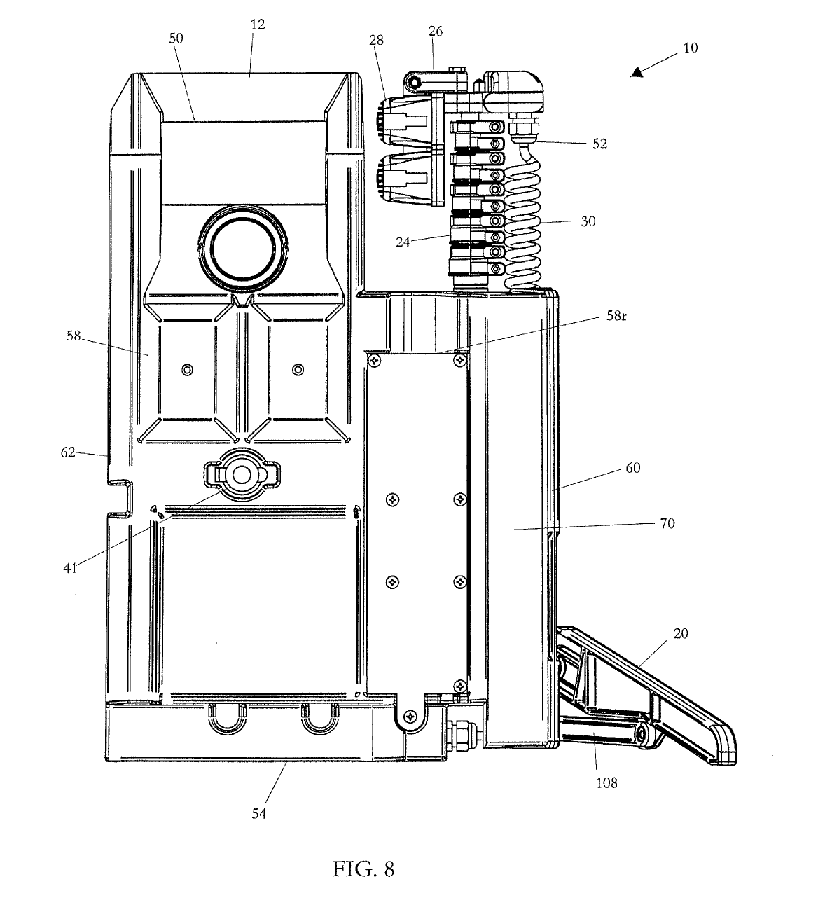

FIG. 9 is a side top plan view of the stand with the legs retracted.

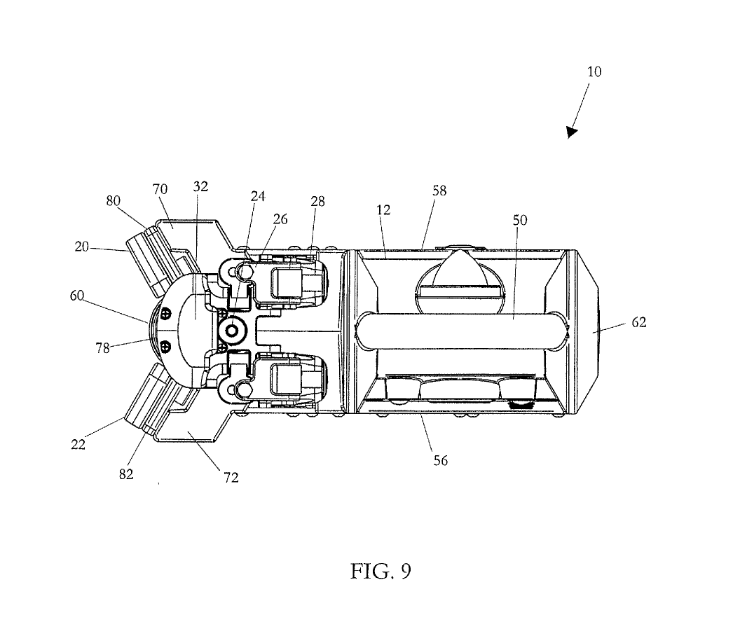

FIG. 10 is a top plan view of the stand with the legs extended.

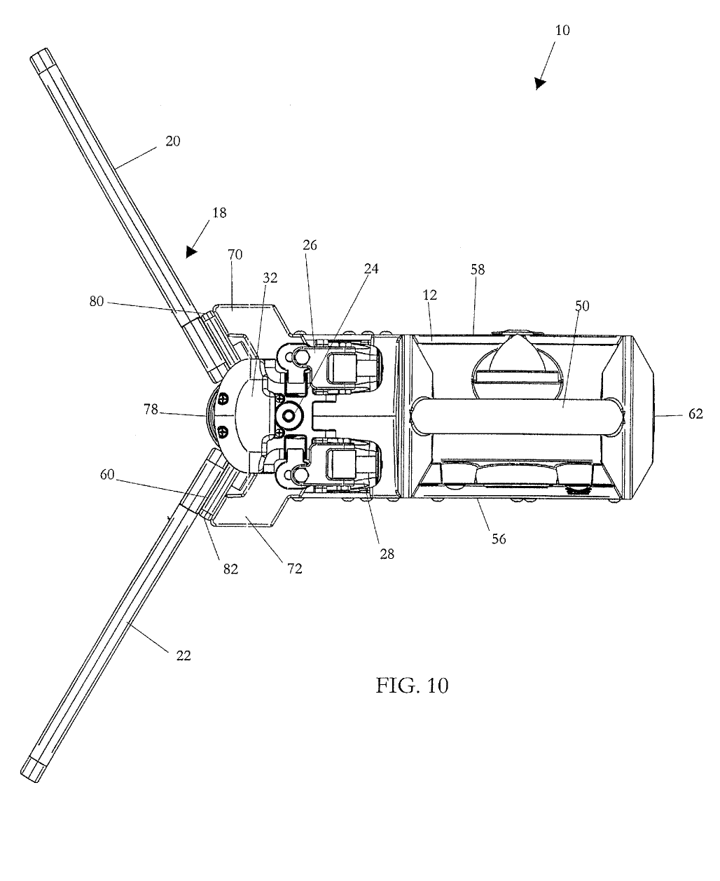

FIG. 11 is a perspective view of the main housing of the stand showing the rear long side wall and the first short side wall.

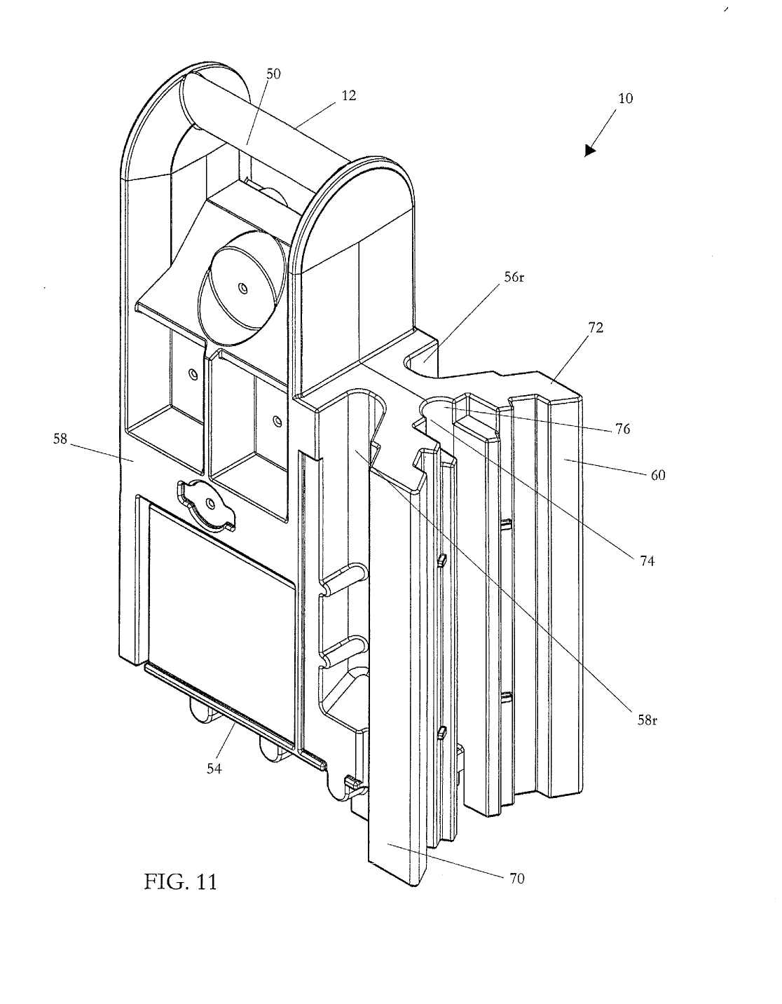

FIG. 12 is a perspective view of the main housing of the stand showing the rear long side wall and the second short side wall.

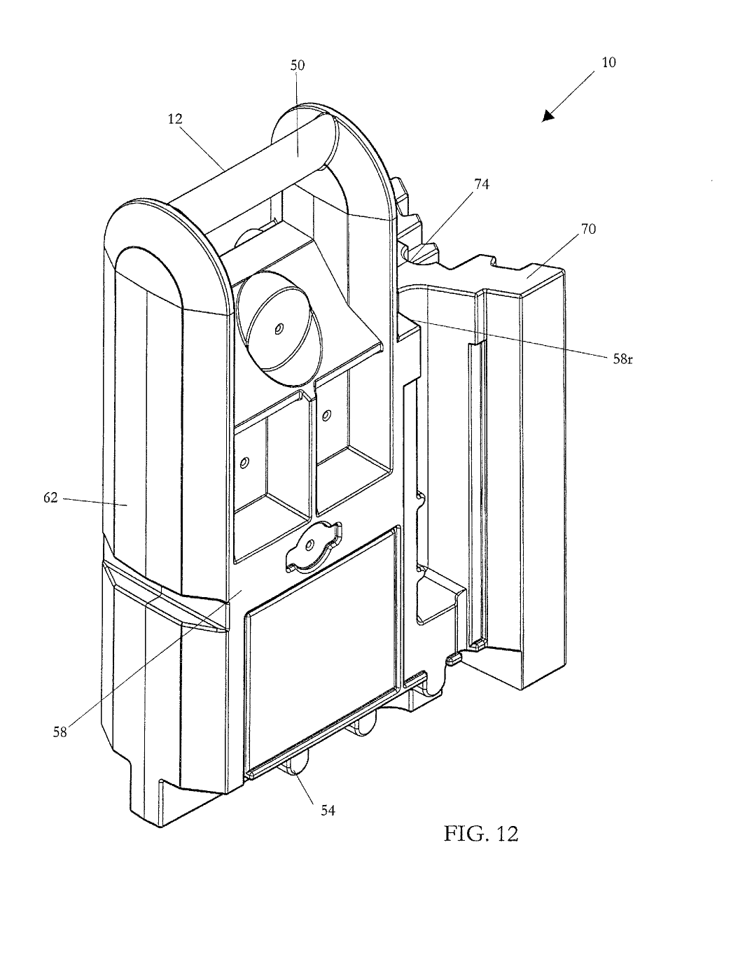

FIG. 13 is a perspective view of the main housing of the present stand showing the front long side wall and the first short side wall.

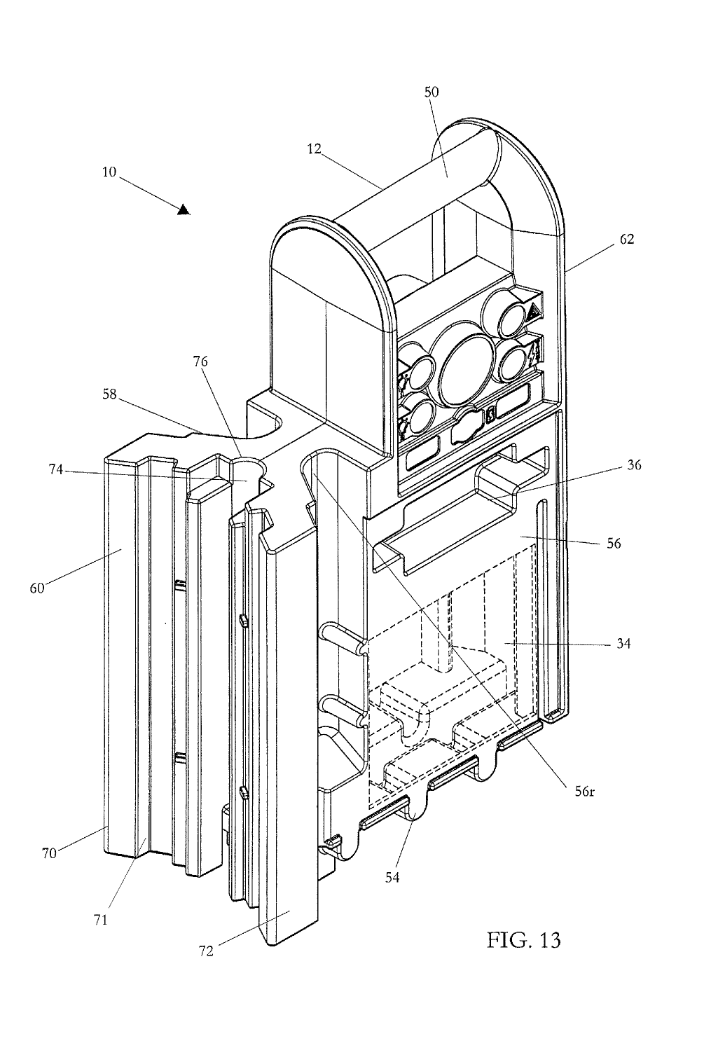

FIG. 14 is a perspective view of the main housing of the present stand showing the front long side wall and the second short side wall.

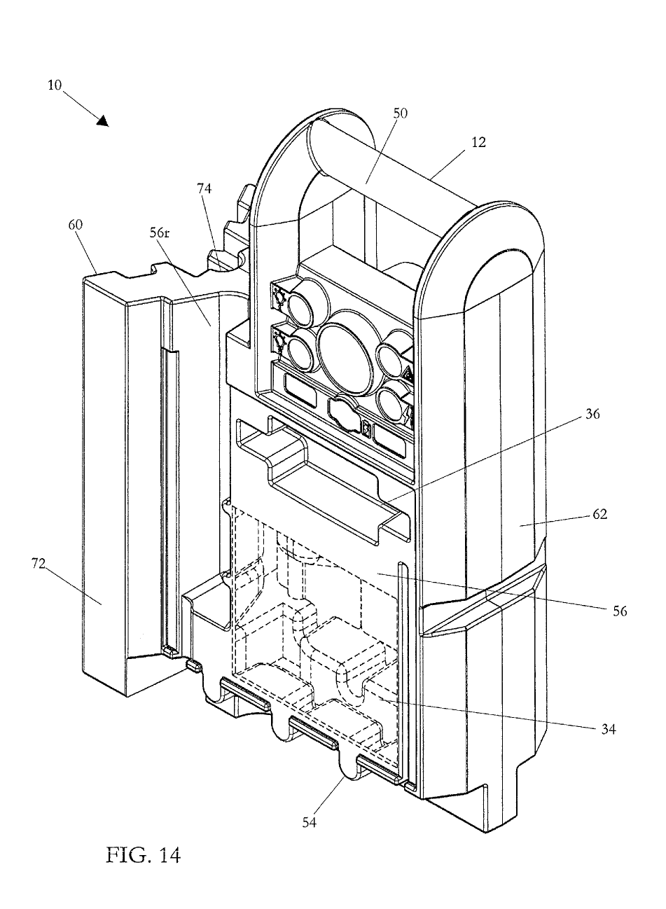

FIG. 15 is a perspective view of an alternate embodiment in its use orientation.

FIG. 16 is a perspective view of the embodiment shown in FIG. 15 in its storage orientation.

FIG. 17 is a side view of the embodiment shown in FIG. 15 in its storage configuration.

FIGS. 18 and 19 are front and rear perspective view of the first base leg assembly of the embodiment shown with reference to FIG. 15.

FIG. 20 is a perspective view of the first leg of the embodiment shown with reference to FIG. 15.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

With reference to the various figures, a stand 10 in accordance with the present invention is disclosed. The stand 10 includes a main housing 12 for holding a power supply 14 and a controller 16. A leg assembly 18 is attached to one end of the main housing 12. The leg assembly 18 allows for outward extension of a pair of opposed legs 20, 22 to increase the stability of the stand 10.

In addition, and as will be explained below in greater detail, the stand 10 includes a telescoping mast 24 attached to the main housing 12. The telescoping mast 24 includes a mount 26 for the selective attachment of a functional device 28 thereto.

Electric power and control signals are transmitted from inside the main housing 12 to the functional device(s) 28 by a flexible spiral power and control conduit 30 in the form of at least one cord that is spiraled to reduce bulk and retract by its own bias. As such, the main housing 12 is preferably sealed from the external environment to create a safer device. In particular, the power and control conduit 30 is contained in a protective containment structure 32 from which it can be extended when the telescoping mast 24 is extended and into which the bias of the spiral and gravity permit retraction into the protective containment structure 32 when the telescoping mast 24 is retracted. In accordance with an alternate embodiment, it is appreciated the control conduit may pass through the telescoping mast, in which case a spring loaded spool inside of the housing would be used automatically retract the power and control conduit when the telescoping mast is retracted. A spring loaded spool may be used where a spiral power and control conduit would be too large to fit within the mast.

Mounted on the top of the telescoping mast 24 is a mount 26 for selective attachment of a functional device 28, for example, a light as shown with reference to the disclosed embodiment. The mount 26 includes a housing that enables electric power and signals from the power and control conduit 30 to be connected to the functional device 28, while also maintaining a weather-type seal. The mount 26 provides for at least two directions of adjustment (also referred to herein as degrees of freedom), so that the functional device(s) 28 can be rotated about the axis of the telescoping mast 24 and pointed up and down. The mount also serves as a junction box for power and control of functional devices attached to the mount. In a preferred embodiment, the power and/or control lines from inside the mount include quick release and attachment plugs for functional devices with mating plugs (preferably such quick release plugs are weather resistant and/or weather proof).

Referring now to the main housing 12, the main housing 12 is preferably constructed from injection molded plastic. The main housing 12 is constructed to maintain an upright configuration with a base 54 and upwardly extending side walls 56, 58, 60, 62. The upwardly extending side walls 56, 68, 60, 62 end in an upper grip 50 allowing for ease of carrying and use on a job site. Given the rectangular configuration of the main housing 12, the main housing 12 includes opposed front and rear long side walls 56, 58 connected by first and second short side walls 60, 62. As will be explained below in greater detail, the various side walls are constructed differently to achieve different functional results.

The main housing 12 also contains at least a power supply cavity 34 and a control cavity 36 in which a power supply 14 and controller 16 are respectively housed. The main housing 12 also includes access ports 40, 41 for recharging the power supply 14 of the main housing 12 and/or connecting the stand 10 to an external power supply 14. In addition, the main housing includes accessory recesses 56r, 58r (for example, for cables) formed along the front and rear long side walls 56, 58.

In accordance with a preferred embodiment, the power supply 14 is a rechargeable battery that is housed within the power supply cavity 34 of the main housing 12 and is, therefore, integrated with the main housing 12. The power supply cavity 34 and controller cavity 36 are covered by a power supply plate 42 enclosing and protecting the power supply 14 from damage during use. Still further, the main housing 12 is provided with a 12 volt power port 41 to which the rechargeable battery 14 is connected for supplying power to external tools that may be connected thereto.

In accordance with a preferred embodiment, the rechargeable battery 14 is connected to a battery fitting maintaining it securely within the main housing 12 and free from the environment. The rechargeable battery 14 is connected with electric connections of the main housing 12 using wiring sufficient to meet the industrial requirements. The power and control conduit 30 leads from the interior of the main housing 12 through a sealed port to provide an external source of power for functional devices 28 from the power supply 14.

As briefly mentioned above, the main housing 12 is manufactured from injection molded plastic. In particular, the main housing 12 is formed of a robust and durable plastic material.

As briefly discussed above, extending from the main housing 12 is a power and control conduit 30 that provides power for functional devices 28 that can be connected to the telescoping mast 24. The power and control conduit 30 is connected to the rechargeable battery 14 and includes an output end 52 that is connected to the mount 26 and ultimately functional devices 28 secured thereto.

With regard to the telescoping mast 24, it is mounted near to and/or engaged with the protective containment structure 32 of the power and control conduit 30 integrally formed with at the first short side wall 60 of the main housing 12. In particular, the first short side wall 60 is constructed such that it creates a V-shape when looking downwardly upon the main housing 12.

The first short side wall 60, therefore, includes a first wall member 70 extending from the center of the first short side wall 60 toward the plane in which the front long side wall 56 lies and a second wall member 72 extending from the center of the first short side wall 60 toward the plane in which the rear long side wall 58 lies. The first and second wall members define an angle of approximately 150 degrees. The extension of the first wall member 70 and the second wall member 72 create a concave cavity 74 in which the telescoping mast 24 is mounted and the protective containment structure 32 is defined. This cavity 74 conforms to the shape of the base of the mast 24, the mast 24 preferably manufactured from metal, so that the plastic of the main housing 12 will not deform under the expected heavy industrial usage requirements.

With regard to the mounting of telescoping mast 24 within the concave cavity 74, it is secured within a recess 76 formed at the meeting point of first wall member 70 and the second wall member 72. The remainder of the recess 76 formed at the meeting point of first wall member 70 and the second wall member 72 is enclosed with an arcuate wall member 78 extending between the first wall member 70 and the second wall member 72 so as to define the protective containment structure 32 through which the power and control conduit 30 extends for attachment with the mount 26 and the functional devices 28.

As briefly discussed above, a functional device mount 26 is secured at the top of the telescoping mast 24. In accordance with a preferred embodiment, lights are utilized as the functional device 28. As such, lights are shown mounted to the functional device mount 26. The lights have electric sockets for connection to the outlet end of the power and control conduit 30. It is appreciated that various other functional devices may be utilized in conjunction with the present invention and that the mast may include more than one mount for greater flexibility and versatility. Such functional device preferably require low voltage.

As mentioned above, the present stand 10 includes a leg assembly 18 at one end of the main housing 12. The leg assembly 18 selectively moves between a retracted formation and an extended formation. The leg assembly 18 is mounted at the first short side wall 60, in particular, it is mounted upon the first wall member 70 and the second wall member 72 of the first short side wall 60.

In accordance with a preferred embodiment, the leg assembly 18 includes adjacent first and second panels 80, 82 respectively secured to the first wall member 70 and the second wall member 72. Each of the first and second panels 80, 82 includes an elongated vertical channel 84, 86 used in the control of the retraction and extension of the first and second legs 20, 22. The first and second legs 20, 22 are pivotally and slidably connected to the first and second panels 80, 82.

Referring to the first leg 20 it includes a first end 92 having a mount hole 94 and a second end 96. In particular, a bolt 98 passing through the channel 84 of the first panel 80 and the mount hole 94 at the first end 92 of the first leg 88 pivotally and slidably connects the first end 92 of the first leg 88 to the first panel 80. Similarly, and with reference to the second leg 90, it includes a first end 100 having a mount hole 102 and a second end 104. A bolt 106 passing through the channel 86 of the second panel 82 and the mount hole 102 at the first end 100 of the second leg 90 pivotally and slidably connects the first end 100 of the second leg 90 to the first panel 82. The bolts are preferably shoulder bolts, wherein a wide top portion of the bolts cannot pass through a hole into which the threaded portion is inserted.

The leg assembly 18 also includes first and second struts 108, 110, each of the first and second struts 108, 110 including a first end 112, 114 and second end 116, 118. The first strut 108 is pivotally connected between the first panel 80 and the first leg 88. In particular, a bolt 120 pivotally connects the first end 112 of the first strut 108 to the lower end of the first panel 80. A bolt 122 pivotally connects the second end 116 of the first strut 108 to a central portion of the first leg 88 between the first end 92 and the second end 96 of the first leg 88. The second strut 110 is pivotally connected between the second panel 82 and the second leg 90. In particular, a bolt 124 pivotally connects the first end 114 of the second strut 110 to the lower end of the second panel 82. A bolt 126 pivotally connects the second end 118 of the second strut 110 to a central portion of the second leg 90 between the first end 100 and the second end 104 of the second leg 90.

The combination of the pivotally connections between the first and second struts 108, 110, the first and second legs 88, 90 and the first and second panels 80, 82, with the pivotal and sliding connection between the first ends 92, 100 of the first and second legs 88, 90 and the channels 84, 86 of the first and second panels 80, 82 creates a linkage assembly permitting the first ends 92, 100 of the first and second legs 88, 90 to slide up and down while the first and second struts 108, 110 limit the travel of the second ends 96, 104 of the first and second legs 88, 90 outward from the first and second panels 80, 82. When the first and second legs 88, 90 are completely retracted so that the first end 92, 100 of each of the first and second legs 88, 90 is near the top of the respective first and second panels 80, 82 and the second ends 96, 104 of the first and second legs 88, 90 is adjacent the respective first and second panels 80, 82, the second end 116, 118 of each of the first and second struts 108, 110 is vertically aligned above the first end 112, 114 of each of the first and second struts 108, 110.

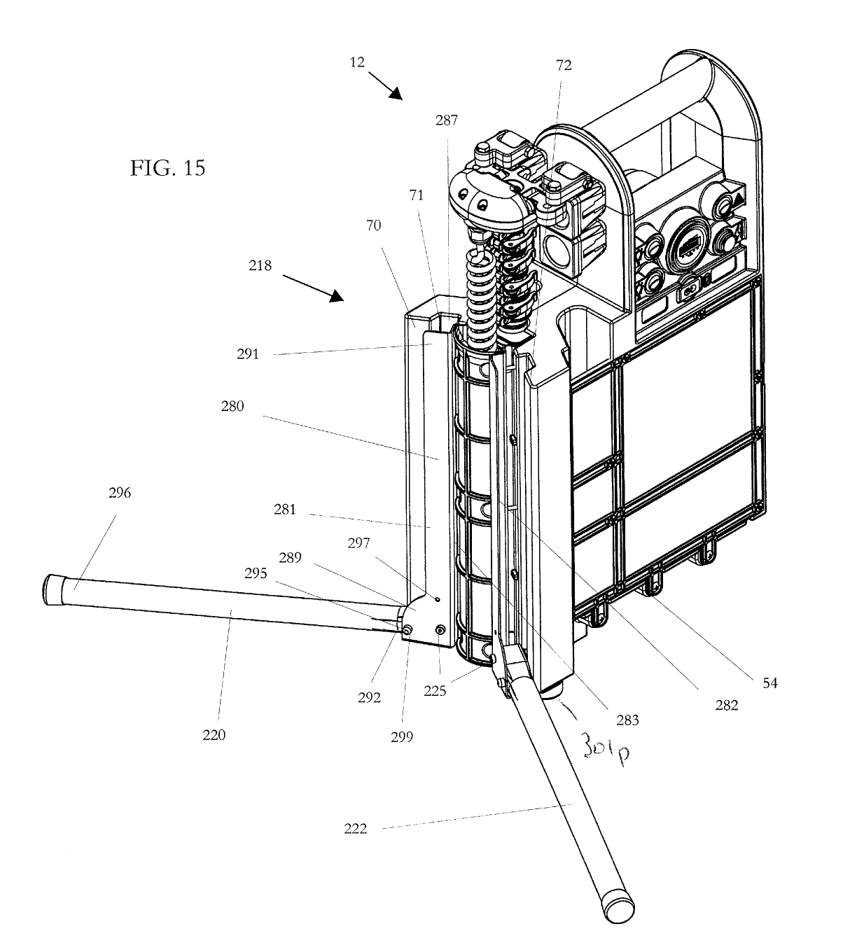

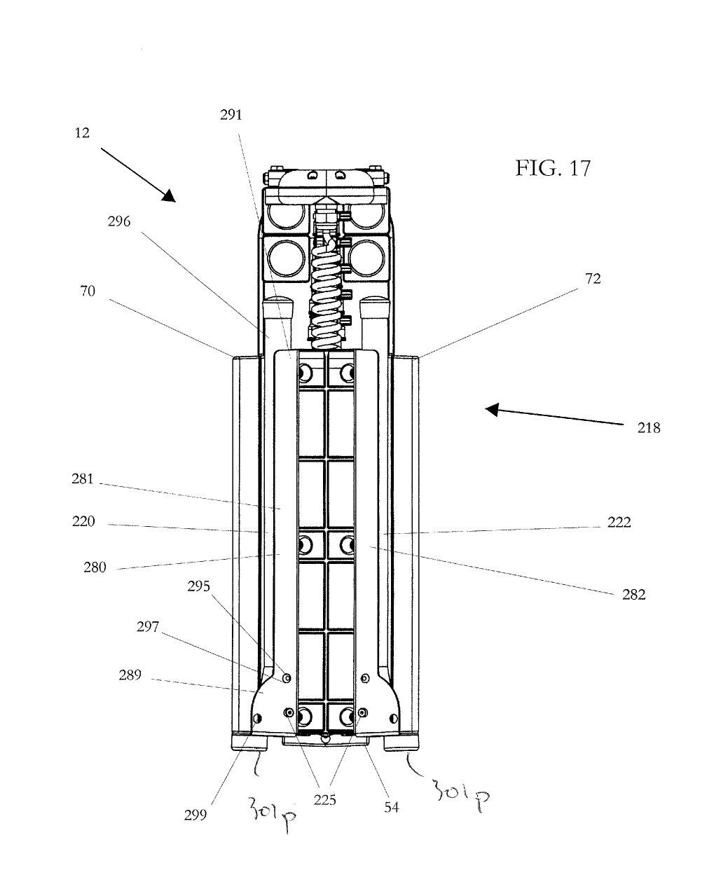

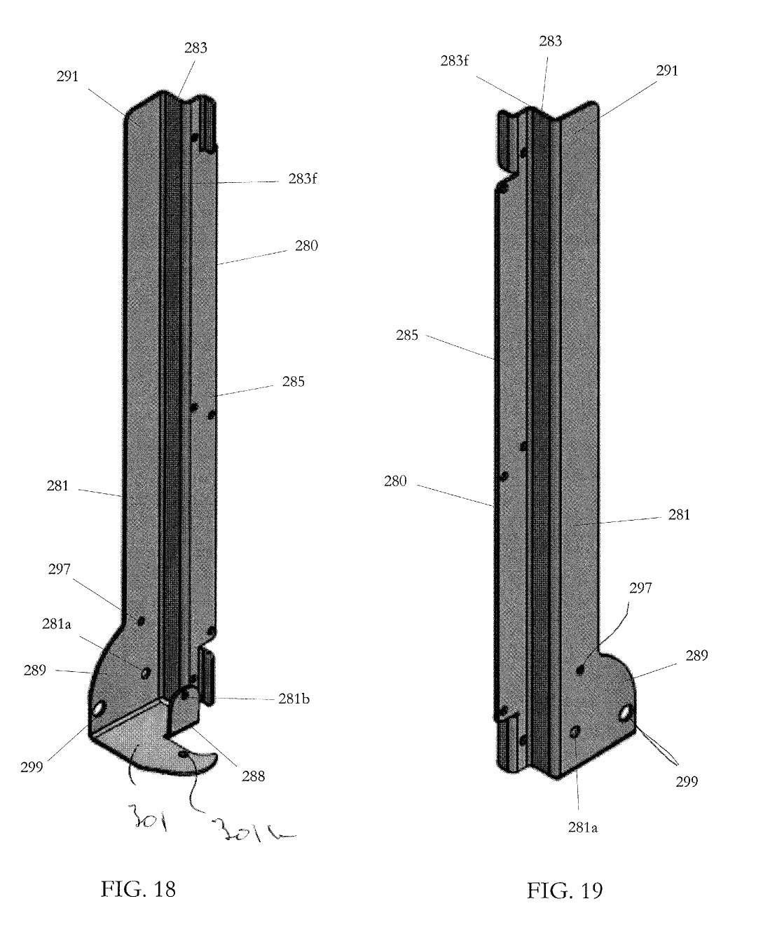

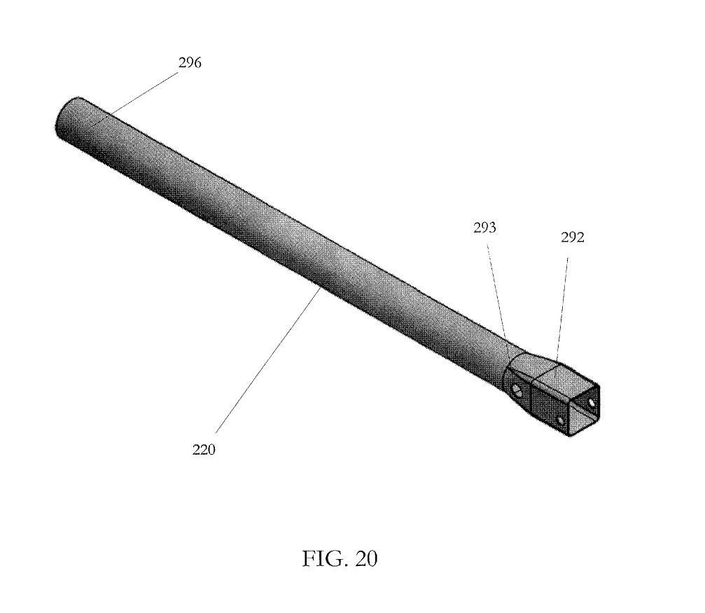

In accordance with an alternate embodiment, the leg structure described above is replaced with an alternate structure as shown with reference to FIGS. 15 to 20. In accordance with the alternate structure, the leg assembly 218 includes first and second base leg assemblies 280, 282 secured to the first wall member 70 and the second wall member 72, and first and second legs 220, 222 pivotally mounted to the first and second base leg assemblies 280, 282. In particular, the first and second legs 220, 222 preferably pivot outward from one of more sides of the main housing 12, but preferably do not horizontally pivot parallel to and in the approximate plane of the base 54 (or bottom) of the main housing 12 as this could cause clogging or interference with the operation of the first and second legs.

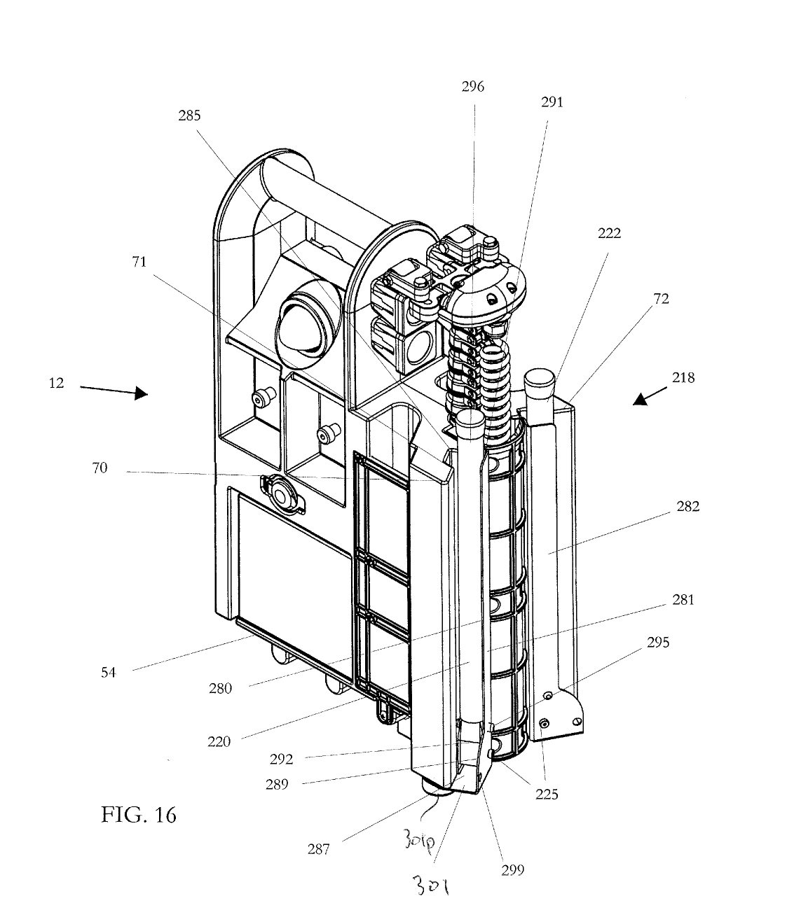

The junction between the respective first and second base leg assemblies 280, 282 and the first and second legs 220, 222 includes a pivot, or hinge, 225 that allows the respective legs 220, 222 to be locked at different positions relative to the hinge 225. In a first position, the first and second legs 220, 222 are vertically oriented in a storage orientation as shown in FIG. 16 and in a second position the first and second legs 220, 222 are horizontally oriented in a use orientation as shown in FIG. 15. The first and second legs 220, 222 are preferably constructed from metal, in particular, square metal ends and cylindrical metal bodies, allowing for ease of construction and use.

It is appreciated the first and second base leg assemblies 280, 282 are identical mirror images, and the first and second legs 220, 222 are similarly identical mirror images. With this in mind, only the first base leg assembly 280 and the first leg 220 will be described below. The first base leg assembly 280 is an elongated member having an L-shaped cross-sectional profile shaped and dimensioned to receive the first leg 220. As such, the first base leg assembly 280 includes a front facing wall 281 and a lateral facing wall 283.

The first base leg assembly 280 also includes a base flange 301 that is perpendicular to the lateral facing wall 283 and positioned adjacent the first end 289 of the first base leg assembly 280. The base flange 301 includes a hole 301h for a fastener to pass through, so that the base flange 301 can be held firmly to a horizontal lower portion along the base 54 of the main housing 12. In accordance with an embodiment, the base flange 301 includes a stabilizing projection 301p that is fastened to the main housing 12 by a threaded connection through the hole 301h in the base flange 301 and is threaded or screwed into a horizontal lower portion the base 54 of the main housing 12. In this way, the projection 301p functions as both the fastener for attaching the base flange 301 to the base 54 of the main housing 12 and as a support member. It is appreciated, the projection 301p can be rotated or otherwise adjusted in vertical spacing from the base 54 of the main housing 12 to facilitate stability on uneven surfaces. In the alternative, the stabilizing projection is separately connected to the main housing (and more than one stabilizing projection may be spaced apart on the main housing bottom).

A connection flange 285 extends from the lateral face wall 283 and is shaped and dimensioned for engagement with a groove 71 formed in the first wall member 70. With the first base leg assembly 280 secured to the first wall member 70 a recess 287 is defined. The recess 287 is shaped and dimensioned to receive the first leg 220 when in its storage position. In particular, the free edge 283f of the lateral facing wall 283 is positioned along the first wall member 70 with the connection flange 285 positioned and secured within the groove 71. With the first side wall 281 secured directly to the first wall member 70 the recess 287 is defined by the front facing wall 281, the lateral facing wall 283 and first wall member, such that the recess 287 faces away from the second wall member 72. In this way, when the first and second legs 220, 222 are in their use orientation they define an angle of approximately 150 degrees.

The first base leg assembly 280 includes a first end 289 positioned near the base 54 of the main housing 12 adjacent a lower end of the first wall member 70 and a second end 291 near the upper end of the first wall member 70. The first leg 220 similarly includes a first end 292 and second end 296 wherein the first end 292 of the first leg 220 is pivotally secured to the first end 289 of the first base leg assembly 280 via a pivot pin 225 extending between apertures 281a, 288a in the first side wall 281 and a flange 288 extending from the lateral facing wall 283 the second side wall 283.

Controlled positioning of the first leg 220 relative to the first base leg assembly 280 in either a storage orientation or a use orientation is achieved by the provision of an alignment hole 293 in the first end 292 of the first leg 220 with a spring pin 295 extending therethrough and alignment holes 297, 299 in the second side wall 281, 283 of the first base leg assembly 280. As such, positioning is achieved by aligning the alignment hole 293 in first leg 220 with either a first alignment hole 297 in the first base leg assembly 280 such that the spring pin 295 engages the first alignment hole 299, which results in positioning and maintenance of the first leg 220 in its storage orientation, or a second alignment hole 299 in the first base leg assembly 280 such that the spring pin 295 engages the second alignment hole 297, which results in positioning of the first leg 220 in its use orientation.

In the embodiment illustrated in the Figures, the leg assembly, in particular the first ends 289 of the first and second base leg assemblies 280, 282 and the first ends 292 of first and second legs 220, 220 are mounted in a manner such that they are spaced above the base 54 of the main housing 12. As such, the first and second legs 220, 222, when fully extended to their use orientation, define an angle with the respective first and second base leg assemblies 280, 282 of slightly greater than 90 degrees. Consequently, only the distal ends at the second ends 296 of the first and second legs 220, 222 touch the ground or surface on which the device is placed (the proximal or first ends of the legs are attached to the main housing). By angling the legs 220, 222 downward from the main housing 12 the device is more stable on uneven ground. It is also contemplated that the base of the main housing may be provided with one or more adjustable stabilizing projections to enhance stability when the main housing must be placed on uneven ground.

Referring now to the mast assembly, as discussed above the telescoping mast 24 is mounted adjacent to the protective containment structure 32 of the power and control conduit 30. It is appreciated the mast may be formed of aluminum and a variety of masts are commonly available. The telescoping mast 24 is composed of a plurality of telescoping elongated members 128 with wing nuts assemblies 130 at their respective ends for controlling expansion and contraction of the telescoping mast 24, and allowing a user to control the expansion of the telescoping mast 24 to a desired height. While a preferred telescoping structure is disclosed in accordance with a preferred embodiment, it is appreciated other adjustment mechanisms may also be utilized. In accordance with a preferred embodiment, the telescoping mast is extendable to a length of eight feet.

As mentioned above, functional devices 28 are attached to the telescoping mast 24 utilizing a mount 26 secured to the free end of the telescoping mast 24. The mount 26 allows for functional devices 28 to be selectively secured thereto and is disclosed in U.S. Patent Application Publication No. 2012/0168576, which is incorporated herein by reference.

Multiple lights 28 may be mounted to the mast, for example, LED lights that provide significant light while using limited power. With this in mind, a stand 10 in accordance with the present invention will weigh less than fifty pounds, more preferably less than forty pounds, while providing adequate portable power to supply lights meeting various road safety requirements (for example, for road flaggers) and/or industrial requirements. Preferably, the lights can be stably mounted at least eight feet above the surface upon which the stand 10 is set. For example, an 800 lumen LED light can provide overhead illumination for highway flaggers up to 200 yards or more. Further, with a charge source, the unit can be continuously charged at 115 VAC and light operations can continue while charging, for example, an embodiment includes a 12 volt power port for quick charge applications.

It is appreciated the present stand offers a relatively small foot print, but is highly stable. This increased stability is achieved by having the telescoping mast 24 centered between the legs 20, 22, 220, 222 and main housing 12. The main housing 12 weight with internal components provides stability for an elevated telescoping mast 24 and functional device mounted thereto. The horizontal footprint of the deployed device, that is, the device when its use orientation, is determined by the length of the extended legs 20, 22, 220, 222 and the length of the main housing 12 measured from the point where the legs 20, 22, 220, 222 connect. The maximum horizontal footprint of the deployed device is calculated by using the larger of the extended leg length and length of the main housing as the radius of a circular footprint, and multiplying π by the square of the radius. Preferably, the maximum circular footprint of the deployed device compared to the maximum mast height is optimized for sufficient stability. In accordance with a preferred embodiment for uses in confined environments, the footprint of the main housing would be less than 9 square feet (ft²).

The stabilizing base or main housing 12 is preferably formed of polyethylene, ABS, or other suitable robust material, while the main housing for the power supply, control panel and mast mount can be the same or of other materials as are customary for such devices used in a variety of rigorous circumstances, for example, road lighting at night, in construction zones, etc. In fact, in some circumstances, it is desired, if not required, that lights be set up at a specific height to light traffic flaggers. The devices of the present invention are ideally suited for holding lights at a height of at least eight feet from the ground, yet are lightweight, durable and easy to set up and collapse, making it an ideal and robust portable platforms for functional devices. For more robust industrial uses, the legs, mast, and other attachments to the main housing must be made of metals, for example, stainless steel, aluminum, etc. Since plastics have different tensile strengths and deformation properties from metals, a problems confronting the present inventor was the avoidance of ripping or tearing of main housing the where the metal components are connected. With the present inventions, this problem is overcome by the inclusion of metal or plastic reinforcements integrated or integrated into the main housing to facilitate connection of legs, masts, etc. at various location about the main housing.

In addition to the lights described above, the functional devices may include, but not are limited to, a microphone, a still camera, an audio output, a visual output, a laser, a weapon, a video camera, a transmitter, a receiver, a weather monitoring device, a solar panel, a surveying device, a motion sensing device, a chemical sensor, a thermal sensor, an alarm, a wind power generator and/or a GPS device.

While the preferred embodiments have been shown and described, it will be understood that there is no intent to limit the invention by such disclosure, but rather, is intended to cover all modifications and alternate constructions falling within the spirit and scope of the invention.

1. A stand, comprising:
a main housing including a power supply cavity and a control cavity in which a power supply and controller are respectively housed, the main housing also includes access ports for external connection with the power supply;
a leg assembly attached to a first side wall of the main housing, the leg assembly allowing for outward extension of a first leg and a second leg to increase the stability of the stand;
a telescoping mast attached to the main housing, the telescoping mast includes a mount for the selective attachment of a functional device thereto;
a power and control conduit connecting the power supply and mount for the transmission of electric power and control signals to the functional device;
wherein the first side wall of the main housing is constructed such that it creates a V-shape and includes a first wall member extending from a center of the first side wall and a second wall member extending from a center of the first side wall, such that the first wall member and the second wall member create a concave cavity in which the telescoping mast is mounted.

2. The stand according to claim 1, wherein the concave cavity, in conjunction with an arcuate wall member extending between the first wall member and the second wall member, define a protective containment structure through which the power and control conduit extends.

3. The stand according to claim 2, wherein the leg assembly includes adjacent first and second panels respectively secured to the first wall member and the second wall member, the first panel having the first leg pivotally connected thereto and the second panel having the second leg pivotally connected thereto.

4. The stand according to claim 1, wherein the leg assembly includes adjacent first and second panels respectively secured to the first wall member and the second wall member, the first panel having the first leg pivotally connected thereto and the second panel having the second leg pivotally connected thereto.

5. The stand according to claim 4, wherein each of the first and second panels includes an elongated vertical channel used in control of the retraction and extension of the first and second legs.

6. The stand according to claim 5, wherein the first leg includes a first end having a mount hole and a second end, a bolt passes through the channel of the first panel and the mount hole at the first end of the first leg to pivotally connect the first end of the first leg to the first panel, and the second leg includes a first end having a mount hole and a second end, a bolt passes through the channel of the second panel and the mount hole at the first end of the second leg to pivotally connect the first end of the second leg to the first panel.

7. The stand according to claim 6, further including a first strut pivotally connected between the first panel and the first leg and a second strut pivotally connected between the second panel and the second leg.

8. The stand according to claim 1, wherein the telescoping mast is secured within a recess formed at a meeting point of first wall member and the second wall member.

9. The stand according to claim 5, wherein the first and second legs are pivotally and slidably coupled to the first side wall.

10. The stand according to claim 1, wherein the first leg and the second leg are made of metal and pivot outwardly from the first side wall of the main housing.
